(19) United States
(12) Patent Application Publication
(10) Pub. No.: US 2025/0144961 A1
(43) Pub. Date: May 8, 2025

(54) Airless Tire with Optimized Shear Strip

(71) Applicant: COMPAGNIE GENERALE DES ETABLISSEMENTS MICHELIN, Clermont-Ferrand (FR)

(72) Inventors: Florian VILCOT, Clermont-Ferrand Cedex 9 (FR); Christophe CHEBAUT, Clermont-Ferrand Cedex 9 (FR)

(21) Appl. No.: 18/719,816

(22) PCT Filed: Dec. 9, 2022
(86) PCT No.: PCT/EP2022/085108

§ 371 Date: Jun. 13, 2024

(30) Foreign Application Priority Data
Dec. 14, 2021 (FR) FR2113425

(51) Int. Cl. B60C 7/14

(52) U.S. Cl. CPC B60C 7/146

(57) ABSTRACT

An airless tire to optimise the mass and stiffness of the shear strip thereof. The tire has a radially inner membrane (41), a shear structure made up of a plurality of shear elements (5), and a radially outer membrane (42) positioned at a mean radial distance H from the radially inner membrane (41). Any shear element (5) of the plurality of shear elements has a main portion (50) having in any circumferential plane (XZ) a non-radial generatrix (G) having a radially inner end (I1) positioned at a distance d1 from the radially inner membrane (41) and a radially outer end (I2) positioned at a distance d2 from the radially outer membrane (42) and the generatrix (G) of the main portion (50) of the shear element (5) has a curvilinear length L at least equal to 1.25*(H−(d1+d2).

The present invention has for object an airless tire intended for a vehicle and more particularly concerns its shear strip.

A conventional tire subjected to the internal pressure of an inflation gas, generally air, has capacities in terms of load, transmission of forces between the ground and the vehicle, and absorption of shocks which make it the preferred choice on a vehicle. However, a risk inherent to the conventional tire is a more or less rapid loss of pressure in the event of shock or of rolling over a perforating object, liable to lead to immobilisation of the vehicle.

Alternative solutions to the conventional tire have been developed to eliminate this risk of loss of pressure such as for example solid tires. A solid tire, which carries the load by compression of its structure, does not have the performance advantages described above for a conventional tire. In particular, a solid tire is generally heavy and rigid, and thus with a lesser capacity to absorb shocks. Furthermore, it has a load capacity that is often low and a shorter service life because of greater heating in use. Consequently, use of a solid tire is limited to specific vehicles such as, by way of non-exhaustive example, materials handling machines.

An airless tire, or more generally a tire with no inflation gas, is another known alternative solution which carries the load thanks to structural components and has performance comparable to that of a conventional tire. An airless tire mounted on a hub or a rim is sometime called a “non-pneumatic elastic wheel”.

Such an airless tire has been described for example in the documents WO 2003018332A1, FR 2964597, WO 2012102932A1, WO 2018101937A1, WO 2018102303A1, WO 2018102560A1, WO 2018125186A1.

Hereinafter the circumferential or longitudinal direction is the direction of rotation of the tire, the axial or transverse direction is the direction parallel to the rotation axis of the tire and the radial direction is a direction perpendicular to the rotation axis of the tire.

An airless tire generally comprises in the radially outward direction:
a supporting structure intended to carry structurally the load at least in part and to cooperate with a rim or a hub,
a shear strip intended to transmit the rolling forces to the supporting structure by shear and to contribute at least in part to carrying the load, and
a tread intended to transmit rolling forces to the shear strip, to suffer wear and to guarantee the adhesion of the tire to the ground.

The supporting structure comprises, for example in the radially outward direction, means for connection to a rim or a hub, radial elements or spokes and means for connection to a shear strip. However, the supporting structure does not generally delimit a sealed internal cavity intended to contain a gas under pressure, as in a conventional tire. Consequently, an airless tire does not need to have a sealed connection to a rim or a hub.

In one known embodiment the shear strip comprises in the radially outward direction:
a first interior membrane,
a shear layer consisting of one or more polymer materials,
a second exterior membrane.
   The shear layer interfaces directly with the first and second membranes.

In the embodiment described above the first and second membranes have a circumferential modulus of elasticity in extension that is often significantly higher than the modulus of elasticity in shear of the polymer material shear layer so that, under the applied load, the membranes are not lengthened much if at all when the tire flattens out when rolling. The movement of the membranes relative to one another occurs by shear in the shear layer. The membranes preferably include stacked reinforcement layers coated with a polymer material.

The polymer material shear layer consists for example of a polymer material such as natural rubber or synthetic rubber or polyurethane. For example, the material of the shear layer has a shear modulus at least equal to 3 MPa and at most equal to 20 MPa, which facilitates flattening out of the shear strip under load.

For a number of years, the company Michelin North America has marketed a complete solution in the form of an assembly consisting of an airless tire as described above and a wheel under the product name MICHELIN® TWEEL®. This technical solution primarily consists of a tread, a shear strip or “shear-band”, a supporting structure consisting of very strong poly-resin spokes, and a hub consisting of two reinforced steel parts.

The shear strips of a prior art airless tire have two main disadvantages, which are a generally high mass and generation of contact pressures with the ground contained within a relative narrow range of values. Thus, high contact pressures can be generated only by a shear strip having a very high mass, which is neither mechanically viable nor economically acceptable. Furthermore, the use of such shear strips is limited in practice to airless tires operating even at low pressure and at high speed, as on a passenger vehicle, or at high pressure and low speed, as on a utility vehicle of Bobcat® type. Furthermore, in applications with severe environmental constraints (for example at very low temperatures) the levels of shear of the shear strip necessary to generate low contact pressures are difficult to achieve with a shear layer consisting of the usual polymer materials.

The inventors have given themselves for objective to propose an airless tire including a shear strip having for a given load capacity of the tire and relative to a prior art shear strip a reduced mass and a shear stiffness adapted to achieve a target medium ground contact pressure level.

That objective has been achieved by an airless tire for a vehicle comprising in the radially outward direction a support structure intended to cooperate with a rim or a hub, a shear strip and a tread,
the shear strip comprising in the radially outward direction a radially inner membrane, a shear structure and a radially outer membrane positioned at a mean radial distance H from the radially inner membrane,
the shear structure consisting of a plurality of shear element distributed circumferentially,
any shear element of the plurality of shear elements including a main portion having in any circumferential plane perpendicular to the rotation axis of the tire a non-radial generatrix having a radially inner end positioned at a distance d1 from the radially inner membrane and a radially outer end positioned at a distance d2 from the radially outer membrane, and
the generatrix of the main portion of the shear element has a curvilinear length L at least equal to 1.25*(H−(d1+d2)).

The shear strip of an airless tire in accordance with the invention essentially includes a circumferential distribution of a plurality of shear elements distributed with a pitch that is not necessarily constant. By convention a plurality of shear elements is a set of shear elements most often comprising all of the shear elements but possibly comprising only some of the shear elements. This discrete shear structure makes it possible to have an open structure shear strip guaranteeing a mass of the summit of the airless tire that can for example be fairly close to that of the summit of a conventional tire. By convention the summit of the tire is the main portion of the tire radially outside the support structure in the case of an airless tire or radially outside the carcass reinforcement in the case of a conventional tire.

The shear strip includes in the radially outward direction a radially inner membrane, a shear structure and a radially outer membrane positioned at a mean radial distance H from the radially inner membrane. By definition the mean radial distance H between the radially inner and radially outer membranes is a mean value over the circumference of the tire.

In any circumferential plane perpendicular to the rotation axis of the tire any shear element, that is to say any elementary motif, of the plurality of shear elements has a circumferential section having a median line called the generatrix that is not radial and is of curvilinear shape. This generatrix extends between a radially inner end position at a distance d1 from the radially inner membrane and a radially outer end position at a distance d2 from the radially outer membrane. This implies that the radially inner and radially outer ends are not necessarily positioned on the radially inner membrane and radially outer membrane, respectively, and consequently that there may be a transition zone serving as the interface between said main portion of the shear element and the radially inner and radially outer membranes. Furthermore, note that the shape of the generatrix is an open curve and not a curve closed on itself. For example, the generatrix cannot have a closed circular shape. The distances d1 and d2 are not necessarily constant in the axial direction of the tire, that is to say may vary within the axial width of the shear strip.

According to the invention this generatrix must have a curvilinear length L measured along the generatrix between its radially inner and radially outer ends at least equal to 1.25 times the shortest distance between its two ends equal to H−(d1+d2). Such a generatrix therefore has a non-zero mean curvature guaranteeing geometrical flexibility of the shear element.

Such a generatrix shape makes possible optimised stresses generated in the shear element when rolling. In fact, compared to simpler structures such as straight beams this generatrix shape makes it possible either to have a longer effective working length of the shear element for a given mean radial intermembrane distance H or to have interfaces with the radially inner and radially outer membranes sufficiently thick to move the maxima of stresses and deformations to the heart of the shear element rather than at the level of said interfaces.

Furthermore, in combination with the thickness characteristics of the shear element and the modulus of elasticity of the material or materials constituting said shear elements the shape of the generatrix enables optimisation of the stiffness mechanical characteristics of the shear strip with a view to obtaining a distribution of and values of the ground contact pressures suitable for the use of the vehicle concerned.

On the one hand the overall stiffness in bending of the shear strip must be sufficiently high to prevent any buckling of the shear strip in the contact with the ground. This overall stiffness in bending is primarily guaranteed by the radially inner and radially outer membranes.

On the other hand, the overall shear stiffness of the shear strip must also be adapted in particular to guarantee the required mean pressure level in the contact area. This overall shear stiffness is conferred primarily by the shear structure between the radially inner and radially outer membranes. Because of the action of the rolling forces the overall shear of such a shear strip generates in each shear element local flexing leading to deformation of that shear element.

A first embodiment of the invention enables design of shear strips generating high ground contact pressures with a mass at the summit of the tire of the same order of magnitude as that at the summit of a conventional tire. Optimisation of the shear strip from the point of view of its overall shear stiffness is achieved by adapting the modulus of the material or materials constituting the shear element and the curvilinear length of the generatrix so that the latter is sufficiently high for the stresses and deformations induced in the material or materials constituting the shear element to be compatible with the resistance to rupture and/or fatigue limit properties of said material. A circumferential distribution of a plurality of shear elements in accordance with the invention makes it possible to obtain a volume of material between the radially inner and radially outer membranes enabling high ground pressures to be achieved at high rolling speeds. This makes it possible to extend the perimeter of use of present-day airless tires.

A second embodiment of the invention makes it possible to design very flexible shear strips compatible with severe environmental constraints such as the extremely low temperatures encountered for example in extraterrestrial environments. This is possible through adapting the length of the generatrix of the shear elements so that it is sufficient for the stresses and deformation induced in the constituent material or materials to be compatible with the resistance to rupture properties and/or fatigue limit properties of said material.

The distance d1 from the radially inner end of the generatrix to the radially inner membrane is advantageously at most equal to 0.5 times the mean radial distance H between the radially inner membrane and the radially outer membrane.

The distance d1 from the radially inner end of the generatrix to the radially inner membrane is also advantageously equal to 0. This implies that there is no transition zone forming the interface between said main portion of the shear element and the radially inner membrane.

The distance d2 from the radially outer end of the generatrix to the radially outer membrane is advantageously at most equal to 0.5 times the mean radial distance H between the radially inner membrane and the radially outer membrane.

The distance d2 from the radially outer end of the generatrix to the radially outer membrane is also advantageously equal to 0. This implies that there is no transition zone forming the interface between said main portion of the shear element and the radially outer membrane.

The tangent to the generatrix at its radially inner end advantageously forms with a radial direction of the airless tire an angle A1 at least equal to 45°.

The tangent to the generatrix at its radially outer end also advantageously forms with a radial direction of the airless tire an angle A2 at least equal to 45°.

The generatrix of the main portion of any shear element advantageously has a shape having a single inversion of its direction of curvature, such as an S shape.

The main portion of any shear element also advantageously has a non-constant thickness E0. This thickness variation makes it possible to optimise the distribution of the stresses and deformation in this shear element. The thickness E0 measures in a given circumferential plane may also vary between two separate circumferential planes, that is to say in the axial direction of the tire.

The shear elements are preferably distributed circumferentially with a constant pitch.

Any shear element also preferably consists of a material having a modulus of elasticity in extension at 4% elongation at least equal to 20 MPa, preferably at least equal to 30 MPa. This modulus of elasticity in extension is measured statically.

The shape of the generatrices of the shear elements has the result that the stresses generated by shear in the shear strip resulting from rolling forces are sufficiently low to allow the use of materials having moduli of elasticity higher than those of the elastomer materials routinely used in the conventional tire field.

Using materials with a high modulus of elasticity makes it possible either to reduce the weight of the shear strip by reducing the effective sections of the shear elements in a circumferential plane or to stiffen the rolling strip in such a manner as to increase the ground contact pressures.

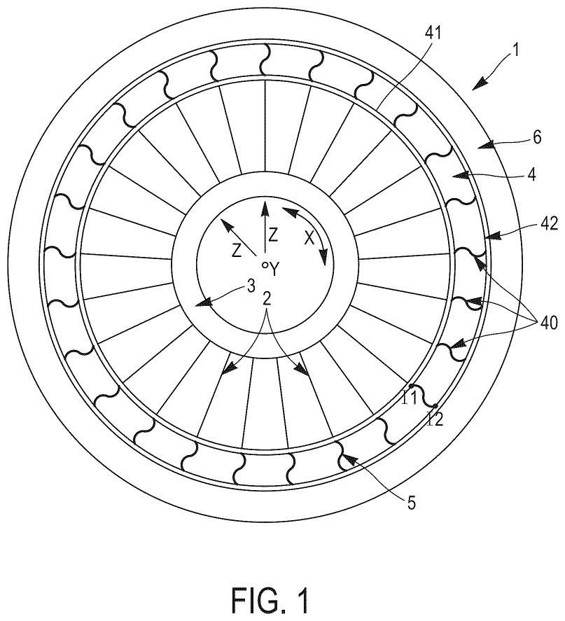

The features of the invention are depicted schematically in FIGS. 1 to 5 and are not represented to scale:

FIG. 1: Overall view of an airless tire in accordance with the invention,

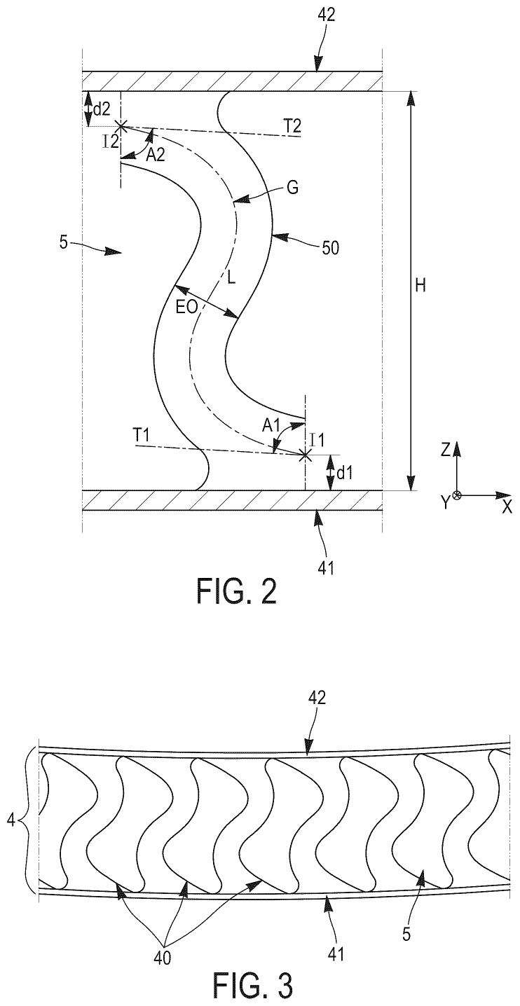

FIG. 2: View in circumferential section of a shear element in accordance with a first embodiment (with non-zero d1 and d2),

FIG. 3: View in circumferential section of a main portion of a shear strip in accordance with a first embodiment (with non-zero d1 and d2),

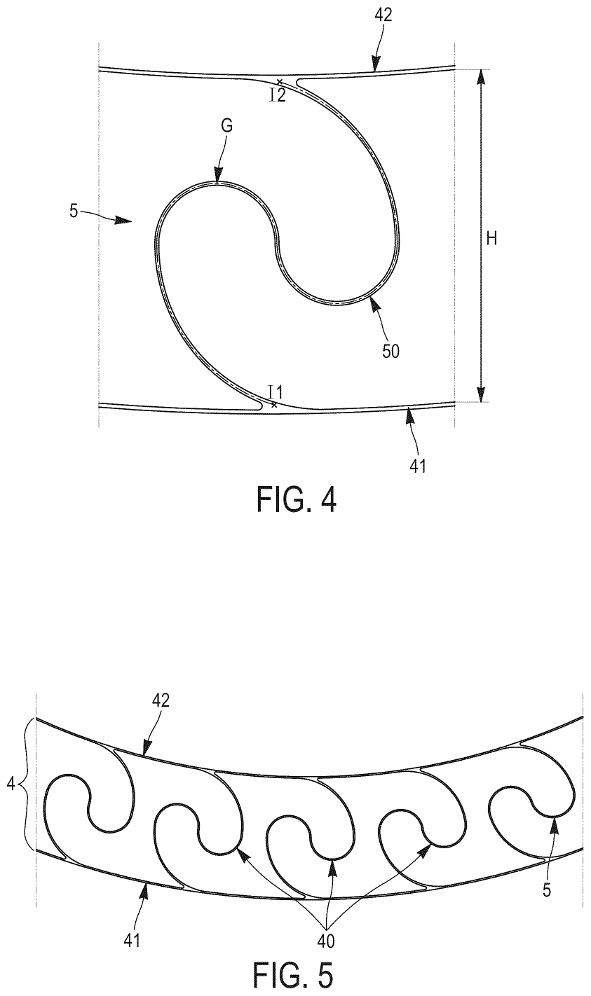

FIG. 4: View in circumferential section of the shear element in accordance with a second embodiment (with zero d1 and d2),

FIG. 5: View in circumferential section of a main portion of a shear strip in accordance with the second embodiment (with zero d1 and d2).

FIG. 1 is an overall view of an airless tire 1 in accordance with the invention. The airless tire 1 comprises in the radially outward direction a supporting structure 2 intended to cooperate with a rim or a hub 3, a shear strip 4 and a tread 6. The shear strip 4 comprises in the radially outward direction a radially inner membrane 41, a shear structure 40 and a radially outer membrane 42. The shear structure 40 consists of a plurality of shear elements 5 distributed circumferentially. Each shear element 5 of the plurality of shear elements has a non-radial generatrix having a radially inner end I1 and a radially outer end I2.

FIG. 2 is a view in the circumferential direction of a shear element 5 in accordance with a first embodiment (with non-zero d1 and d2). The shear element 5 includes a main portion 50 having in any circumferential plane XZ perpendicular to the rotation axis of the tire a non-radial generatrix G having a radially inner end I1 positioned at a distance d1 from the radially inner membrane 41 and a radially outer end I2 positioned at a distance d2 from the radially outer membrane 42 and the generatrix G of the main portion 50 of the shear element 5 has a curvilinear length L at least equal to 1.25*(H−(d1+d2)), H being the mean radial distance between the radially inner membrane 41 and the radially outer membrane 42. In the embodiment represented the distance d1 from the radially inner end I1 of the generatrix G to the radially inner membrane 41 and the distance d2 from the radially outer end 12 of the generatrix G to the radially outer membrane 42 are less than 0.5 times the mean radial distance H and not zero. Furthermore the tangent T1 to the generatrix G at its radially inner end I1 forms with a radial direction ZZ′ of the airless tire 1 an angle A1 at least equal to 45° and even close to 90°. In an analogous manner the tangent T2 to the generatrix G at its radially outer end I2 forms with the radial direction ZZ′ of the airless tire 1 an angle A2 at least equal to 45° and even close to 90°. Finally, the generatrix G of the main portion 50 of the shear element 5 has an S shape and the main portion 50 of the shear element 5 has a constant thickness E0.

FIG. 3 is a view in circumferential section of a main portion of a shear strip 4 in accordance with the first embodiment (with non-zero d1 and d2). The shear strip 4 comprises in the radially outward direction a radially inner membrane 41, a shear structure 40 and a radially outer membrane 42. The shear elements 5 are of the type described with reference to FIG. 2.

FIG. 4 is a view in circumferential section of a shear element 5 in accordance with a second embodiment (with zero d1 and d2). This shear element 5 differs from that in FIG. 2 by a shape of the generatrix G with more marked curvatures, a longer generatrix length G and a smaller main portion thickness. Furthermore, the distance d1 from the radially inner end I1 of the generatrix G to the radially inner membrane 41 and the distance d2 from the radially outer end 12 of the generatrix G to the radially outer membrane 42 are zero. In other words, the main portion 50 is a direct interface with the radially inner membrane 41 and the radially outer membrane 42.

FIG. 5 is a view in circumferential section of a main portion of a shear strip 4 in accordance with the second embodiment (with zero d1 and d2). As previously stated, the shear strip 4 comprises in the radially outward direction a radially inner membrane 41, a shear structure 40 and a radially outer membrane 42. The shear elements 5 are of the type described with reference to FIG. 4.

The inventors have more particularly studied this invention in two different embodiments R1 and R2.

A first embodiment R1 concerns an airless tire aiming to replace a reference tire with dimensions 235/65 R16 LI/SI 121R as defined in the European Standard of the European Tire and Rim Technical Organization (ETRTO) in its Standards Manual 2020 intended to equip van-type vehicles. For R1 the modulus of elasticity in extension at 4% elongation of the material constituting a shear element is equal to 150 MPa, corresponding for example to a thermoplastic elastomer (TPE).

A second embodiment R2 concerns an airless tire having an outside diameter equal to 800 mm and an overall width equal to 300 mm intended to equip a vehicle adapted to travel in an extreme environment at very low temperatures. For R2 the modulus of elasticity in extension at 4% elongation and at −200° C. of the material constituting a shear element is equal to 5800 MPa, corresponding for example to a poly ether ether ketone (PEEK) type thermoplastic or a polyimide.

Table 1 below sets out the respective features of the two embodiments R1 and R2:

TABLE 1

| Characteristic | R1 | | R2 | | Comments |
|---|---|---|---|---|---|
| Mean radial distance H | 25 | mm | 60 | mm | |
| between the radially inner | | | | | |
| membrane 41 and the | | | | | |
| radially outer membrane 42 | | | | | |
| (mm) | | | | | |
| Distance d1 between the | 0.5 | mm | 0 | mm | R1: d1 < 0.5*H = 12.5 mm |
| radially inner end I1 of the | | | | | R2: d1 = 0 mm |
| generatrix G and the | | | | | |
| radially inner membrane 41 | | | | | |
| (mm) | | | | | |
| Distance d2 between the | 0.5 | mm | 0 | mm | R1: d2 < 0.5*H = 12.5 mm |
| radially outer end I2 of the | | | | | R2: d2 = 0 mm |
| generatrix G and the | | | | | |
| radially outer membrane 42 | | | | | |
| (mm) | | | | | |
| Curvilinear length L of the | 32.9 | mm | 153.6 | mm | R1: L > 1.25*(H − (d1 + d2)) = 30 |
| generatrix G (mm) | | | | | mm |
| | | | | | R2: L > 1.25*(H − (d1 + d2)) = 75 |
| | | | | | mm |
| Angle A1 of the tangent T1 | 90° | | 76° | | R1: A1 > 45° |
| to the generatrix G at its | | | | | R2: A1 > 45° |
| radially inner end I1 (°) | | | | | |
| Angle A2 of the tangent T2 | 90° | | 76° | | R1: A2 > 45° |
| to the generatrix G at its | | | | | R2: A2 > 45° |
| radially outer end I2 (°) | | | | | |
| Modulus of elasticity in | 150 | MPa | 5800 | MPa | R1: Modulus at 4% > 30 MPa |
| extension at 4% elongation | | | | | R2: Modulus at 4% >> 30 MPa |
| of the constituent material | | | | | |
| of a shear element (MPa) | | | | | |

According to numerical simulations carried out by the inventors using finite element calculation software the mean ground contact pressure generated by the shear strip of the tire in accordance with the first embodiment R1 is equal to 5 bar for a shear strip mass equal to 8.7 kg.

According to numerical simulations carried out by the inventors using finite element calculation software the mean ground contact pressure generated by the shear strip of the tire in accordance with the second embodiment R2 is equal to 0.075 bar.

1. An airless tire for a vehicle comprising in the radially outward direction a support structure intended to cooperate with a rim or a hub, a shear strip and a tread,
the shear strip comprising in the radially outward direction a radially inner membrane, a shear structure and a radially outer membrane positioned at a mean radial distance H from the radially inner membrane,
the shear structure consisting of a plurality of shear element distributed circumferentially, Wherein any shear element of the plurality of shear elements includes a main portion having in any circumferential plane (XZ) perpendicular to the rotation axis of the tire a non-radial generatrix (G) having a radially inner end (I1) positioned at a distance d1 from the radially inner membrane and a radially outer end (I2) positioned at a distance d2 from the radially outer membrane, and the generatrix (G) of the main portion of the shear element has a curvilinear length L at least equal to 1.25*(H−(d1+d2).

2. The airless tire according to claim 1 wherein the distance d1 from the radially inner end (I1) of the generatrix (G) to the radially inner membrane is at most equal to 0.5 times the mean radial distance H between the radially inner membrane and the radially outer membrane.

3. The airless tire according to claim 1, wherein the distance d1 from the radially inner end (I1) of the generatrix (G) to the radially inner membrane is equal to 0.

4. The airless tire according to claim 1, wherein the distance d2 from the radially outer end (I2) of the generatrix (G) to the radially outer membrane is at most equal to 0.5 times the mean radial distance H between the radially inner membrane and the radially outer membrane.

5. The airless tire according to claim 1, wherein the distance d2 from the radially outer end (I2) of the generatrix (G) to the radially outer membrane is equal to 0.

6. The airless tire according to claim 1 wherein the tangent (T1) to the generatrix (G) at its radially inner end (I1) forms with a radial direction (ZZ′) of the airless tire an angle A1 at least equal to 45°.

7. The airless tire according claim 1, wherein the tangent (T2) to the generatrix (G) at its radially outer end (I2) forms with a radial direction (ZZ′) of the airless tire an angle A2 at least equal to 45°.

8. The airless tire according to claim 1, wherein the generatrix (G) of the main portion of any shear element has a shape having a single inversion of its direction of curvature.

9. The airless tire according to claim 1, wherein the main portion of any shear element has a non-constant thickness E0.

10. The airless tire according to claim 1, wherein the shear elements are distributed circumferentially with a constant pitch.

11. The airless tire according to claim 1, wherein any shear element of the plurality of shear elements consists of a material having a modulus of elasticity in extension at 4% elongation at least equal to 20 MPa, preferably at least equal to 30 MPa.
